(19) United States
(12) Patent Application Publication
(10) Pub. No.: US 2009/0310020 A1
(43) Pub. Date: Dec. 17, 2009

(54) ENHANCED "TICKER" APPLICATION

(75) Inventor: Alexander Petrus Paulus Vrijsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/306,107

(22) PCT Filed: Jul. 3, 2007
(86) PCT No.: PCT/IB07/52596

§ 371 Date: Dec. 22, 2008

(30) Foreign Application Priority Data
Jul. 5, 2006 (EP) 06116661.7

(51) Int. Cl. H04N 5/445

(52) U.S. Cl. 348/564; 348/E05.101

(57) ABSTRACT

A method (300) of transmitting a television signal including an information ticker, includes embedding (310) a ticker, including first ticker data, into a video stream; including (320) second ticker data in a separate data stream; multiplexing (330) the video stream and the separate data stream to create a digital television transport multiplex; and broadcasting (340) a broadcast television signal including the digital television transport multiplex, the digital television transport multiplex further including the video stream and the separate data stream, wherein the ticker including the first ticker data is embedded in the video stream and wherein the second ticker data is included in the separate data stream.

### TECHNICAL FIELD

This invention pertains to multimedia data for a television signal, and in particular to a method of broadcasting and receiving enhanced “ticker” data and functionality in a broadcast television signal.

### TECHNICAL BACKGROUND

As used herein, a “ticker” refers to a scrolling display wherein new information or data appears and enters a display area at one end of the display screen (typically, the right hand side) and scrolls across the display screen to the opposite end (typically the left hand side) where it departs the screen. Also, as used herein, a signal is said to be “broadcast” whenever it is transmitted from a source to be received by multiple destination terminals, whether that source be a terrestrial broadcast transmitter, a satellite transmitter, or a cable head-end. The presence of any wireless repeaters or amplifiers and signal splitters in a cable system does not negate the broadcast nature of the signal.

Various “tickers” included in television video signals are well known. Examples include news tickers, sports tickers, and stock quote tickers included in terrestrial, cable, or satellite broadcast television signals.

These tickers are generally encoded in the same analog or digital signal as the television signal. For instance, in the case of an ATSC digital television signal, in one case a graphics generator or other mechanism may generate the ticker at a production studio (or other location) and then combine the ticker with the television video signal. The combined video is then encoded with Motion Pictures Experts Group (MPEG) digital encoding, such that the ticker is embedded within the video information that is broadcast in the MPEG stream. The television signal with the embedded ticker is then broadcast to viewers.

Because such tickers are embedded in the video signal at the transmission end, a user or viewer has no control over the content or operation of the ticker. This can lead to viewer dissatisfaction with the content and/or operation of the ticker.

So, for example, when there are many stocks in a stock ticker, a viewer may have to wait a very long time while many stocks of no interest to the viewer scroll by, until she/he sees a stock of interest. Furthermore, some viewers may want more detailed—or enhanced quality—information with respect to one or more items in the ticker. For other viewers, current tickers are completely absent of any information for items of interest.

In short the current ticker solutions are based on the ticker embedded in the video stream and therefore they do not offer any flexibility in dealing with the ticker data on the user end. As a consequence at the user end they force the user to wait passively until the information desired by the user occurs on the ticket, and hope to read the information quickly enough before the information disappears from the display.

Meanwhile, enhanced platforms with interactivity capabilities are becoming available, such as a multimedia home platform (MHP), an OpenCable application platform (OCAP), an Association of Radio Industries and Businesses—Japan (ARIB) application execution engine platform, etc. Also, digital television broadcast signals can now multiplex generic data signals into the broadcast signal. For example, in the U.S. the Advanced Television Systems Committee (ATSC) has adopted the ATSC Data Broadcast Standard Doc. A/90 (see also ISO/IEC 13818-6:1998/AMd 2: 2000). According to that standard, data streams may be multiplexed with video streams and audio streams to form transport multiplexes. Such data streams may include, for example, data for enhanced or interactive services associated with a television program.

However, further complicating matters is the fact that while some viewers are beginning to watch television programs on an enhanced platform with interactivity capabilities, many or most viewers are still using legacy “dumb display” devices, even in the case of digital television receivers, which cannot use all of the data available in data streams that are included in transport multiplexes.

### SUMMARY OF THE INVENTION

Accordingly, it would be desirable to provide an enhanced ticker application for a television signal. It would also be desirable to provide such an application which provides enhanced ticker capability for interactive devices, while maintaining ticker capability for legacy display devices. The present invention is directed to addressing one or more of the preceding concerns. It overcomes the shortcomings of the current ticker solutions by offering the user an opportunity to deal with the ticker data in a flexible way.

In one aspect of the invention, a method of transmitting a television signal including an information ticker comprises: embedding a ticker including first ticker data into a video stream; including second ticker data in a separate data stream; multiplexing the video stream and the separate data stream to create a digital television transport multiplex; broadcasting a broadcast television signal including the digital television transport multiplex, the digital television transport multiplex further including the video stream and the separate data stream, wherein the ticker including first ticker data is embedded in the video stream, and wherein the second ticker data is included in the separate data stream.

This means that the second ticker data is provided in a separate data stream decoupled from the video stream. This allows the receiver on the user end to deal flexibly with the second ticker as it can be easily extracted (demultiplexed) from the received video stream. Thanks to the separation of the second ticker data the user is offered an opportunity to choose between the current first ticker data embedded in the video stream with its limitations and the second ticker data provided in the separate data stream, therefore enabling a wide range of new enhanced ticker applications to be applied on the second ticker.

When an additional source data needs to be included in the second ticker the following happens. The ticker including first ticker data embedded into the video stream remains unchanged. The second ticker data is modified to include the new source data. Subsequently the modified ticker data is included in the separate data stream. The multiplexer mixes the two streams, i.e. the video stream with the first ticker embedded, the separate data stream comprising the second ticker, into a digital television transport multiplex that is further broadcast.

Separating the second ticker from the first ticker and transmitting the second ticker data in a separate data stream enables the receivers to have more degrees of freedom in the way the second ticker is presented to the user. The second ticker, since not embedded in the video stream but multiplexed with it. This allows the second ticker to be manipulated independently of the displayed video stream comprising the first ticker. The second ticker can be displayed for example next to the first ticker or in place of the first ticker.

In another aspect of the invention, a method of processing ticker information received with a broadcast television signal comprises: receiving a broadcast television signal comprising a digital television transport multiplex, including a video stream and a separate data stream, wherein a first ticker including first ticker data is embedded in the video stream, and wherein second ticker data is included in the separate data stream; recovering the video stream from the digital television transport multiplex, and producing therefrom a video signal for display, including the embedded first ticker; creating a second ticker including at least a selected portion of the second ticker data; combining the second ticker with the video signal to produce a modified video signal, wherein the combined video signal includes the second ticker next or in place of the first ticker; and providing the modified video signal to a display device to display the second ticker.

This allows creating the modified video signal that is displayed to the user. This modified video signal comprises the signal corresponding to the video stream and the signal corresponding to the second ticker, so that the second ticker is next or replaces the first ticker.

In another aspect of the invention, a method wherein the data stream includes an enhanced ticker application further comprises: extracting the enhanced ticker application from the data stream; and executing the enhanced ticker application to control the second ticker. This allows the second ticker to be manipulated according to the enhanced ticker application. Such application can prescribe the location the ticker should be displayed, the way the ticker should be displayed, etc.

In another aspect of the invention, a method further comprises: receiving an instruction from a viewer to select a data item in the second ticker and to perform an additional operation with respect to the selected data item; and performing the additional operation with respect to the selected data item. This allows the user to influence the manner the ticker is displayed on the display, but also it enables the user to manipulate the data being displayed in the ticker. For example the enhanced ticker application may provide a “hot spot” on display screen around a portion of the ticker. Alternatively, the additional operation may entail performing a transaction with the viewer with respect to the selected data item, for example purchasing shares of a stock in a stock ticker.

In another aspect of the invention, a method further comprises: receiving an instruction from a viewer to alter a speed or direction of the second ticker; and in response thereto, altering a speed or direction of the second ticker. This allows the user to have control over the occurrence of the thicker data on the display. In response to the user instruction provided via user interface the enhanced ticker application may pause, fast forward, or even reverse the second ticker. This way the user can quickly and in a friendly way to allocate the desired information comprised in the second ticker.

Further and other aspects will become evident from the description to follow.

### BRIEF DESCRIPTION OF THE DRAWINGS

FIG. 1 is a functional block diagram of a broadcast television transmitter;

FIG. 2 is a functional block diagram of a broadcast television receiver;

FIG. 3 is a flowchart of a method of transmitting a television signal including an information ticker;

FIG. 4 is a flowchart of one embodiment of a method of processing ticker information received with a broadcast television signal; and

FIG. 5 is a flowchart of a second embodiment of a method of processing ticker information received with a broadcast television signal.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided as teaching examples of the invention.

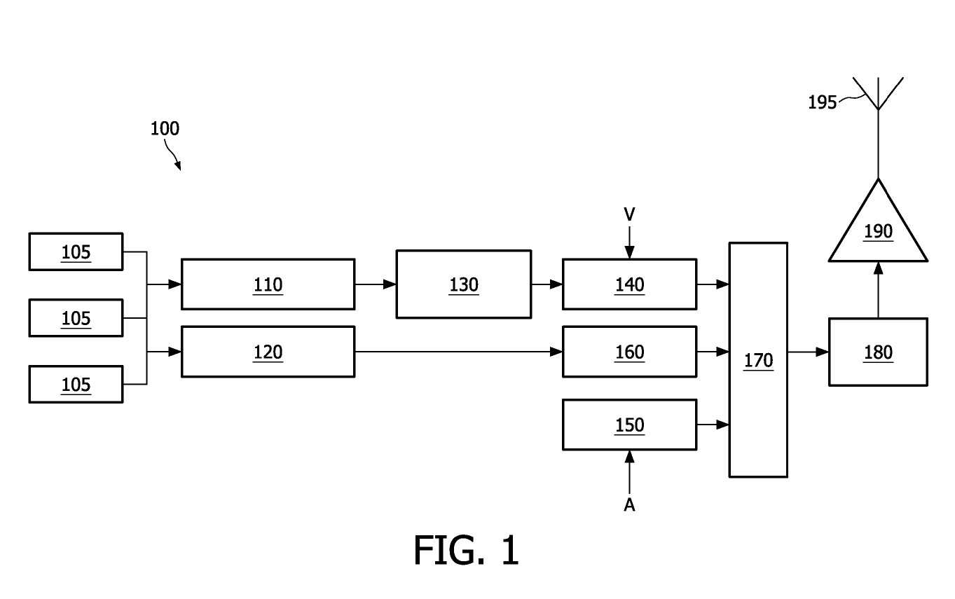

FIG. 1 is a functional block diagram of one embodiment of a broadcast television transmitter 100. As will be appreciated by those skilled in the art, the various “parts” shown in FIG. 1 may be physically implemented using a software-controlled microprocessor, hard-wired logic circuits, or a combination thereof. Also, while the parts are functionally segregated in FIG. 1 for explanation purposes, they may be combined in any physical implementation. Furthermore, many conventional parts of broadcast television transmitter 100 that are not relevant to the discussion to follow (e.g., power supplies) have been omitted for simplification.

Broadcast television transmitter 100 includes one or more data sources 105, a first ticker generator 110, a second ticker generator 120, a graphics generator 130, a video processor 140, an audio processor 150, a data processor 160, a multiplexer 170, a modulator 180, an amplifier 190, and a transmit antenna 195.

Operationally, data is received by data source(s) 105. Such data may include news headlines, sports scores, stock quotes, etc.

Data received by data source(s) 105 is then provided to both first and second ticker data generators 110 and 120. Ticker generators 110, 120 generate first and second ticker data, respectively, containing some or all of the data received by data source(s) 105.

The first ticker data produced by first ticker generator 110 is provided to graphics generator 130 where a ticker comprising the first ticker data is embedded in the source video signal. The video signal with the embedded first ticker is then provided to video processor 140, into which the video to be broadcast that is indicated by a letter V in the figure is fed, to produce a video stream for broadcast.

Meanwhile, the second ticker data produced by second ticker generator 120 is provided to data processor 160 where it is combined with other data signals to produce a data stream for broadcast. In one embodiment, data processor 160 operates a data carousel in conformance with ATSC Data Broadcast Standard Doc. A/90 (see also ISO/IEC 13818-6: 1998/AMd 2: 2000). Beneficially, in one embodiment the data stream also includes an enhanced ticker application which can be recovered and executed by some enhanced receivers for displaying and controlling the second ticker data. The enhanced ticker application may be embodied in a compiled software program, an applet (e.g., a Java applet), or “xlet” or other embodiment that may be conveniently recovered from the data stream and executed by an advanced receiver (e.g., a multimedia home platform (MHP), an OpenCable application platform (OCAP), etc.).

The audio signal corresponding to the video to be broadcast that is indicated by a letter A in the figure is fed into the audio processor 150.

Multiplexer 170 multiplexes the audio, video, and data streams to create a digital television transport multiplex. Modulator 180 then modulates the digital television transport multiplex onto a carrier signal to create a broadcast television signal. In one embodiment, modulator 180 modulates the digital television transport multiplex onto a carrier signal using 8-VSB modulation. Alternatively, outside the United States, modulator 180 modulates the digital television transport multiplex onto a carrier signal using a different modulator scheme, such as coded orthogonal frequency division multiplexing (COFDM).

Amplifier 190 amplifies the broadcast television and provides the amplified broadcast television signal to antenna 195 which transmits the broadcast television signal over the air.

Although the embodiment of FIG. 1 pertains to a terrestrial broadcast television transmitter, alternatively a television signal including an information ticker could be broadcast by a satellite or a cable head-end. In that case, other modulation formats (e.g., M-QAM) may be employed.

Accordingly, the broadcast television transmitter 100 broadcasts a broadcast television signal comprising a digital television transport multiplex, including a video stream and a separate data stream, wherein a ticker including first ticker data is embedded in the video stream, and wherein second ticker data is included in the separate data stream. This broadcast television signal may be received by a plurality of receivers, including first receivers (“dumb displays”) that cannot interpret or display the second ticker data of the data stream, and second receivers (“enhanced platforms”) that can recover, interpret, and display the second ticker data of the data stream. In the case of the first receivers, then the embedded ticker including the first ticker data is displayed to a viewer, as normal. In the case of the second receivers, then enhanced ticker functionality can be provided to a viewer by using the second ticker data together with, or perhaps in place of, the first ticker data.

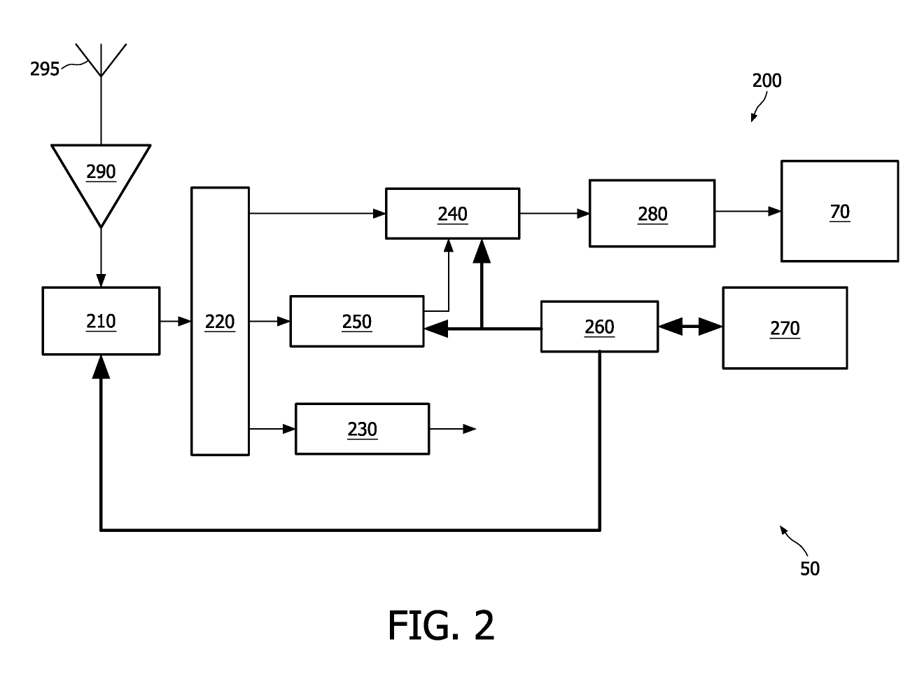

FIG. 2 is a functional block diagram of a first embodiment of a broadcast television receiver 200. As will be appreciated by those skilled in the art, the various “parts” shown in FIG. 2 may be physically implemented using a software-controlled microprocessor, hard-wired logic circuits, or a combination thereof. Also, while the parts are functionally segregated in FIG. 2 for explanation purposes, they may be combined in any physical implementation. Receiver 200 includes a receive antenna 295, an amplifier 290, a demodulator 210, a demultiplexer 220, an audio stream processor 230, a video stream processor 240, a data stream processor 250, a controller 260, a user interface 270, and a display driver 280. In one embodiment, receiver 200 may be integrated in a television receiver 50, including a display device 70. Alternatively, receiver 200 may be implemented as a so-called “set-top box” which is connected to a separate display device 70. Furthermore, many conventional parts of broadcast television receiver 200 that are not relevant to the discussion to follow (e.g., power supplies) have been omitted for simplification.

Operationally, receiver 200 is adapted to be connected to an external connector (not shown) whereby it receives one or more broadcast television signals, such as terrestrial digital television signals, cable television signals, satellite television signals, etc. from an antenna, a cable, etc.

Beneficially, receiver 200 receives a broadcast television signal comprising a digital television transport multiplex, including a video stream and a separate data stream, wherein a first ticker including first ticker data is embedded in the video stream, and wherein second ticker data is included in the separate data stream. An explanation of the operation of receiver 200 follows in the case when it receives the broadcast television signal as described above.

In receiver 200, one or more broadcast television signal(s) are amplified by the amplifier 201 and further provided to demodulator 210 which selects a desired broadcast television signal, and demodulates the selected broadcast television signal to produce a digital television transport multiplex including an audio stream, a video stream, and a data stream. The digital television transport multiplex is demultiplexed by demultiplexer 220 to produce audio, video, and data streams that are then processed by audio stream processor 230, video stream processor 240, and data stream processor 250, respectively.

The audio stream processor 230 provides the audio further to audio circuits.

The video stream comprises the video signal with the embedded first ticker, and the data stream includes the second ticker data. Beneficially, the data stream also includes an enhanced ticker application which can be recovered and executed by receiver 200 for displaying and controlling the second ticker data. The enhanced ticker application may be embodied in a compiled software program, an applet (e.g., a Java applet), or other embodiment that may be conveniently recovered from the data stream and executed by receiver 200, e.g., by controller 260. Alternatively, the enhanced ticker application may be pre-installed in receiver 200, e.g., in executable code memory associated with controller 260.

In one embodiment, receiver 200 processes the video stream to produce a video signal including the embedded first ticker. In that case, the video signal including the embedded first ticker is provided by display driver 280 to display device 70, where the first ticker is displayed to a viewer. Meanwhile, receiver 200 (e.g., via controller 260) executes an enhanced ticker application. In that case, a viewer may provide an instruction via user interface 270 to select a data item in the first ticker and to perform an additional operation with respect to the data item. For example, the enhanced ticker application may provide a “hot spot” on display screen 70 around a portion of the ticker (e.g., at the bottom left where the data items leave display screen 70). In that case, a user may press a button on a remote control unit with is part of user interface 270 when the desired data item is in the “hot spot,” to identify the data item with respect to which the additional operation is to be performed. The additional function may also be communicated to receiver 200 via user interface 270, for example by a choice of which button on a remote control is pressed by the user, through selection of an item in a pull-down screen menu, etc. The additional operation may entail displaying additional data associated with the selected data item, wherein the additional data is included in the second ticker data that was received in the data stream by receiver 200. In another case, the additional operation may entail performing a transaction with the viewer with respect to the selected data item (e.g., purchasing shares of a stock in a stock ticker). In yet another case, the first ticker data may include time-delayed stock market quote data, while the second ticker data includes real-time stock market data. In that case, the additional operation may entail enabling the real-time stock market data to be displayed to the viewer (typically for a fee).

Alternatively, when the second ticker comprises the textual or meta data the user can, for example, search through such data to quickly allocate and subsequently to display the desired information. Another operations such as filtering or selecting certain items of information, text processing, font, substitution, feeding to a text-to-speech engine, and such like are also possible. A variety of other additional operations are of course possible.

In another embodiment, the enhanced ticker application creates a second ticker including at least a selected portion of the second ticker data. Then, receiver 200 combines the second ticker with the video signal to produce a modified video signal, wherein the modified video signal includes the second ticker in place of the first ticker. Display driver 280 provides the modified video signal including the second ticker to display device 70. Beneficially, in this case the second ticker is displayed under control of the enhanced ticker application. As noted above, the enhanced ticker application may be recovered from the data stream and executed by receiver 200, or it may be pre-installed in receiver 200. In this case, beneficially, in response to user instructions provided via user interface 270, the enhanced ticker application may pause, fast forward, or even reverse the second ticker. Furthermore, as in the first embodiment, a viewer may provide an instruction via user interface 270 to select a data item in the ticker and to perform an additional operation with respect to the data item (e.g., displaying additional data associated with the selected data item, wherein the additional data is included in the second ticker data that was received in the data stream by receiver 200; performing a transaction with the viewer with respect to the selected data item; enabling the real-time stock market data to be displayed to the viewer (typically for a fee)).

Thus receiver 200 is able to extract and utilize the second ticker data from the data stream and provide enhanced functionality to a viewer. At the same time, however, the exact same broadcast television signal can be received by a “dumb display” receiver that cannot utilize the second ticker data, and the viewer will still be able to view a ticker with the first ticker data.

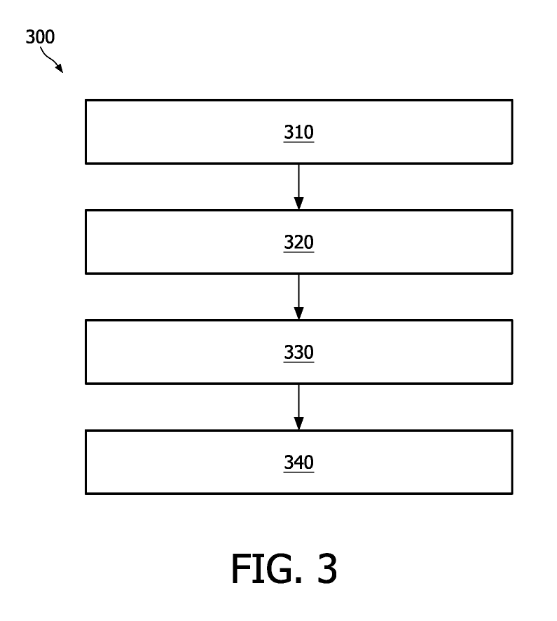

FIG. 3 is a flowchart of a method 300 of transmitting a television signal including an information ticker.

In a first step 310, a first ticker including first ticker data is embedded into a video stream.

In a second step 320, second ticker data is included in a separate data stream. In one embodiment, the data stream also includes an enhanced ticker application that can be recovered and executed by a receiver for displaying and controlling a ticker.

In a third step 330, the video stream and the separate data stream are multiplexed to create a digital television transport multiplex.

Finally, in a step 340, a broadcast television signal is broadcast. The broadcast television signal includes the digital television transport multiplex, modulated onto a carrier signal using an appropriate modulation format, as discussed above. In turn, the digital television transport multiplex includes the video stream and the separate data stream. The first ticker including the first ticker data is embedded in the video stream, and the second ticker data is included in the separate data stream.

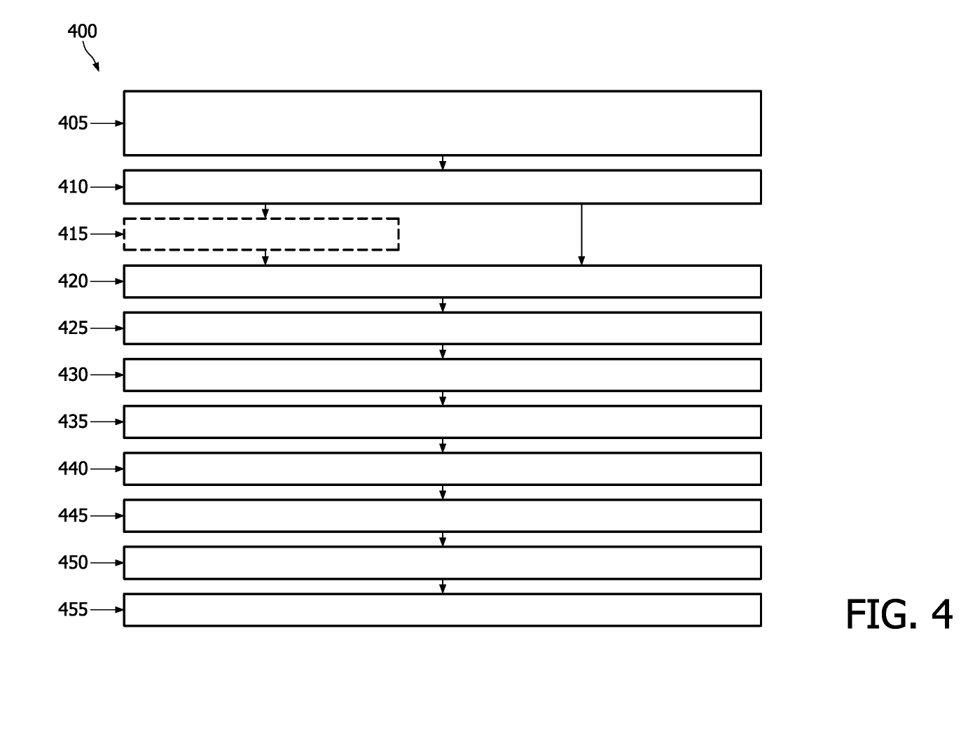

FIG. 4 is a flowchart of one embodiment of a method 400 of processing ticker information received with a broadcast television signal.

In a first step 405, a broadcast television signal is received comprising a digital television transport multiplex, including a video stream and a separate data stream, wherein a first ticker including first ticker data is embedded in the video stream, and wherein second ticker data is included in the separate data stream.

In a next step 410, the video stream is recovered from the digital television transport multiplex, and a video signal, including the embedded first ticker, is produced therefrom.

In an optional step 415, an enhanced ticker application is recovered from the data stream. Alternatively, the enhanced ticker application may have already been pre-installed.

In a step 420, the second ticker data is recovered from the data stream of the digital television transport multiplex.

In a step 425, a second ticker is created including at least a selected portion of the second ticker data. The second ticker is combined with the video signal to produce a modified video signal, wherein the modified video signal includes the second ticker in place of the first ticker.

In a step 430, the modified video signal is provided to a display device to display the second ticker.

In a step 435, the enhanced ticker application controls the second ticker.

Then, in a step 440, an instruction is received from a viewer to select a data item in the second ticker and to perform an additional operation with respect to the selected data item (e.g., displaying additional data associated with the selected data item, wherein the additional data is included in the second ticker data that was received in the data stream; performing a transaction with the viewer with respect to the selected data item; enabling the real-time stock market data to be displayed to the viewer (typically for a fee)).

Subsequently, in a step 445, the additional operation is performed with respect to the selected data item by the enhanced ticker application.

Furthermore, in a step 450 a viewer instruction may be received to alter a speed or direction of the second ticker. Examples include a viewer pressing a button on a remote control to fast forward the scrolling ticker, to reverse the scrolling ticker, to pause the scrolling ticker, etc.

In response to this instruction, in a step 455 the speed or direction of the second ticker is altered by the enhanced ticker application.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A method (300) of transmitting a television signal including an information ticker, comprising:
embedding (310) a ticker, including first ticker data, into a video stream;
including (320) second ticker data in a separate data stream;
multiplexing (330) the video stream and the separate data stream to create a digital television transport multiplex;
broadcasting (340) a broadcast television signal including the digital television transport multiplex, the digital television transport multiplex further including the video stream and the separate data stream, wherein the ticker including the first ticker data is embedded in the video stream, and wherein the second ticker data is included in the separate data stream.

2. The method (300) of claim 1, wherein broadcasting a broadcast television signal including the transport multiplex includes:
modulating the digital television transport multiplex onto a carrier signal using 8-VSB modulation to create a broadcast television signal; and
terrestrially broadcasting the broadcast television signal.

3. The method (300) of claim 1, wherein broadcasting a broadcast television signal including the transport multiplex includes:
modulating the digital television transport multiplex onto a carrier signal using M-QAM modulation to create a broadcast television signal; and
broadcasting the broadcast television signal over a cable television system.

4. The method of claim 1, wherein broadcasting a broadcast television signal including the transport multiplex includes:
modulating the digital television transport multiplex onto a carrier signal to create a broadcast television signal; and
broadcasting the broadcast television signal over a satellite transmission system.

5. The method (300) of claim 1, wherein the data stream includes an enhanced ticker application that can be recovered and executed by a receiver for controlling display of the second ticker data in response to a viewer instruction.

6. The method (300) of claim 5, wherein the enhanced ticker application is adapted to create a second ticker that overlays the first ticker, wherein the enhanced ticker application is adapted to pause, fast forward, and reverse display of the second ticker.

7. A method (400) of processing ticker information received with a broadcast television signal, comprising:
receiving (405) a broadcast television signal comprising a digital television transport multiplex, including a video stream and a separate data stream, wherein a first ticker including first ticker data is embedded in the video stream, and wherein second ticker data is included in the separate data stream;
recovering (410) the video stream from the digital television transport multiplex, and producing therefrom a video signal for display, including the embedded first ticker;
recovering (420) the second ticker data from the data stream of the digital television transport multiplex;
creating (425) a second ticker including at least a selected portion of the second ticker data;
combining (425) the second ticker with the video signal to produce a modified video signal, wherein the modified video signal includes the second ticker next or in place of the first ticker; and
providing (430) the modified video signal to a display device to display the second ticker.

8. The method (400) of claim 7, wherein the data stream includes an enhanced ticker application, and further comprising:
extracting (415) the enhanced ticker application from the data stream; and
executing (435) the enhanced ticker application to control the second ticker.

9. The method (400) of claim 7, further comprising:
receiving (440) an instruction from a viewer to select a data item in the second ticker and to perform an additional operation with respect to the selected data item; and
performing (445) the additional operation with respect to the selected data item.

10. The method (400) of claim 9, wherein the additional operation comprises displaying additional data associated with the selected data item, wherein the additional data is included in the second ticker data.

11. The method (400) of claim 9, wherein the additional operation comprises performing a transaction with the viewer with respect to the selected data item.

12. The method (400) of claim 9, wherein the second ticker data includes time-delayed stock market quote data and real-time stock market data, and wherein the additional operation comprises enabling the real-time stock market data to be displayed to the viewer.

13. The method (400) of claim 7, further comprising:
receiving (450) an instruction from a viewer to alter a speed or direction of the second ticker; and
in response thereto, altering (455) a speed or direction of the second ticker.

14. A broadcast television transmitter (100) for transmission of a television signal including an information ticker, said transmitter comprising:
a means (130, 140) for embedding a ticker, including first ticker, into a video stream;
a means (160) for including second ticker data in a separate data stream;
a multiplexing means (170) for multiplexing the video stream and the separate data stream to create a digital television transport multiplex;
a broadcasting means (180, 190, 195) for broadcasting a broadcast television signal including the digital television transport multiplex, the digital television transport multiplex further including the video stream and the separate data stream, wherein the ticker including the first ticker data is embedded in the video stream, and wherein the second ticker data is included in the separate data stream.

15. A broadcast television receiver (200) for processing ticker information received with a broadcast television signal, said receiver comprising:
a means (201, 210) for receiving a broadcast television signal comprising a digital television transport multiplex, including a video stream and a separate data stream, wherein a first ticker including first ticker data is embedded in the video stream, and wherein second ticker data is included in the separate data stream;
a means (220, 240) for recovering the video stream from the digital television transport multiplex, and producing therefrom a video signal for display, including the embedded first ticker;
a means (220) for recovering the second ticker data from the data stream of the digital television transport multiplex;
a means (250) for creating a second ticker including at least a selected portion of the second ticker data;
a means (240) for combining the second ticker with the video signal to produce a modified video signal, wherein the modified video signal includes the second ticker in place of the first ticker; and
a means (280) for providing the modified video signal to a display device to display the second ticker.

16. A broadcast television receiver (200) as claimed in claim 15, further comprising a means for extracting the enhanced ticker application from the data stream, and a means for executing the enhanced ticker application to control the second ticker.

17. A broadcast television receiver (200) as claimed in claim 15, further comprising a means (270) for receiving an instruction from a viewer to select a data item in the second ticker and to perform an additional operation with respect to the selected data item, and a means (260) for performing the additional operation with respect to the selected data item.

18. A broadcast television receiver (200) as claimed in claim 15, further comprising a means (270) for receiving an instruction from a viewer to alter a speed or direction of the second ticker, and in response thereto, altering a speed or direction of the second ticker.
